(19) United States
(12) Patent Application Publication
(10) Pub. No.: US 2005/0230521 A1
(43) Pub. Date: Oct. 20, 2005

(54) Powerchute apparatus

(76) Inventors: James A. Medsker, Lawton, MI (US); Daniel J. Richardson, Schoolcraft, MI (US); Matt F. Dautle, Three Rivers, MI (US); Robert William Taylor, Plainwell, MI (US); Shawn R. Brueshaber, Kalamazoo, MI (US); Benjamin M. Marvin, Constantine, MI (US); John C. Shimer, Three Rivers, MI (US)

Correspondence Address: King & Jovanovic, PLC, Suite 230, 170 College Avenue, Holland, MI, 49423, US

(21) Appl. No.: 10/669,126

(22) Filed: Sep. 23, 2003

(51) Int. Cl. B64C 1/00

(52) U.S. Cl. 244/13; 244/903

(57) ABSTRACT

A powerchute comprising a body having an outer shell and an inner reinforcement. The outer shell including a nose, opposing side panels, a roll bar and a powerplant shelf, wherein a plurality of the nose, opposing side panels, roll bar and powerplant shelf define a cavity including a cabin. The outer shell and the inner reinforcement comprise a carbon fiber composite which is of sufficient strength to maintain rigidity and structural integrity without the use of metal support members.

### BACKGROUND OF THE INVENTION

1. Field of the Invention

The present invention relates in general to a powerchute, and more particularly to a powerchute apparatus which is configured from a composite material and which include a multitude of structural features and enhancements over conventional powerchute apparatuses.

2. Background Art

Powerchutes have become increasingly popular. Generally, such powerchutes comprise a frame which is formed from a number of tubes which are attached together by way of welding or by way of other securement. Increasingly, adaptations have been made to powerchutes to enhance safety and durability. While such adaptations have been made, conventional chutes suffer from multiple drawbacks.

First, most designs fail to provide an adequate cabin or cavity from which to operate the powerchute. As such, inadvertently items are dropped from the powerchute—often in flight. Some enclosures have been developed in an effort to define a cabin. These solutions suffer from two major drawbacks. First, the underlying construction of such powerchutes comprises a metal frame with panels attached thereto. Such a construction adds undue weight to the system making performance less than acceptable. Second, the panels that are added generally form have an effect of a sail due to the large surface area. In turn, the yaw characteristics are greatly degraded, and the overall the stability of the powerchute is compromised. With limited engine sizes, such drawbacks are quite significant. Third, none of the prior attempted enclosures contemplated a full canopy enclosure.

Second, most designs fail to incorporate a suspension which can adequately absorb the shock. Indeed, prior art suspension is generally incapable of correcting for improper and difficult landings that may be encountered. Moreover, most designs fail to incorporate geometries which are suitable for use in association with powercrafts and the particular flight and landing effects of a powercraft.

Thus, it is an object of the invention to provide a powercraft which includes a cabin structure formed from a composite and weight bearing material.

It is another object of the invention to provide a powercraft cabin while maintaining the stability of the powerchute and acceptable yaw characteristics.

It is yet another object of the invention to provide a landing gear which is capable of absorbing powerchute landings, and which is capable of controlling powerchutes, and the dynamics associated with same while on the ground.

These objects as well as other objects of the present invention will become apparent in light of the present specification, claims, and drawings.

### SUMMARY OF THE INVENTION

The invention comprises a powerchute comprising a body having an outer shell and an inner reinforcement. The outer shell includes a nose, opposing side panels, a roll bar and a powerplant shelf. A plurality of the nose, opposing side panels, roll bar and powerplant shelf define a cavity including a cabin. The outer shell and the inner reinforcement comprise a carbon fiber composite which is of sufficient strength to maintain rigidity and structural integrity without the use of a metal frame.

In a preferred embodiment, the outer shell and the inner reinforcement are secured together by way of an epoxy. In one embodiment, an at least partially transparent canopy may be provided.

In another preferred embodiment, at least one of the outer shell and the inner reinforcement further comprises a yaw control rail. In a preferred embodiment, the yaw control rail further comprises a channel extending along the body. In one such embodiment, the channel includes opposing side surfaces and a top. Preferably, the cross-sectional area of the channel at any point of along the length thereof is substantially uniform.

In another preferred embodiment, the vehicle further includes a powerplant assembly having an engine and a propeller coupled therewith. The engine is coupled with the powerplant shelf. The propeller is positioned such that the propeller passes beyond a region proximate the yaw control rail during a rotation thereof.

In a preferred embodiment, the powerchute further includes a front landing gear and a rear landing gear, the rear landing gear comprises a torsional suspension component, opposing trailing arms extending outwardly and downwardly away from the torsional suspension component, opposing axles are associated with each opposing trailing arm proximate a far end thereof, and, opposing wheels are associated with each of the opposing axles.

In one such preferred embodiment, the opposing trailing arms initiate in a substantially outward horizontal configuration proximate the torsional suspension component and terminate proximate the opposing axles in a substantially vertical orientation. Preferably, the opposing trailing arms comprise substantially uniformly tubular components.

In a preferred embodiment, the chute further comprises a chute attachment assembly. The chute attachment assembly comprises opposing arms mounted to opposing body mounts. The opposing arms including plates which extend on either side of the respective body mount and secure the body mount between the plates.

In another preferred embodiment, the opposing arms are connected to each other within the cavity defined by the outer shell. In one embodiment, the opposing arms are each secured to opposing side panels by way of a cable.

In another embodiment, the opposing body mounts further comprise a core and opposing carbon fiber composite panels substantially encapsulating the core. Preferably, the core comprises a wood material.

### BRIEF DESCRIPTION OF THE DRAWINGS

The invention will now be described with reference to the drawings wherein:

FIG. 1 of the drawings is a perspective view of the powerchute apparatus of the present invention;

FIG. 2 of the drawings is a partial perspective view of the powerchute apparatus of the present invention, showing in particular, an interior view of the passenger cavity thereof;

FIG. 3 of the drawings is a back elevational view of the powerchute apparatus of the present invention;

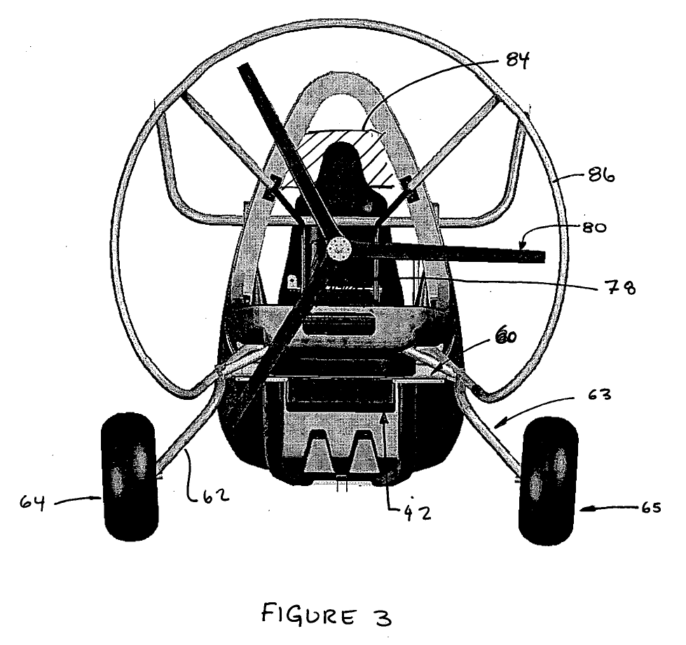

FIG. 4 of the drawings is a partial back elevational view of the powerchute apparatus of the present invention, showing in particular, the engine mount thereof and the suspension thereof;

FIG. 5 of the drawings is a partial front perspective view of the powerchute apparatus of the present invention, showing in particular, the yaw stabilizing assembly thereof;

FIG. 6 of the drawings is a side elevational view of the powerchute apparatus of the present invention; and

FIG. 7 of the drawings is a schematic side elevational view showing the installation of a canopy.

### DETAILED DESCRIPTION OF THE INVENTION

While this invention is susceptible of embodiment in many different forms, there is shown in the drawings and described herein in detail a specific embodiment with the understanding that the present disclosure is to be considered as an exemplification of the principles of the invention and is not intended to limit the invention to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

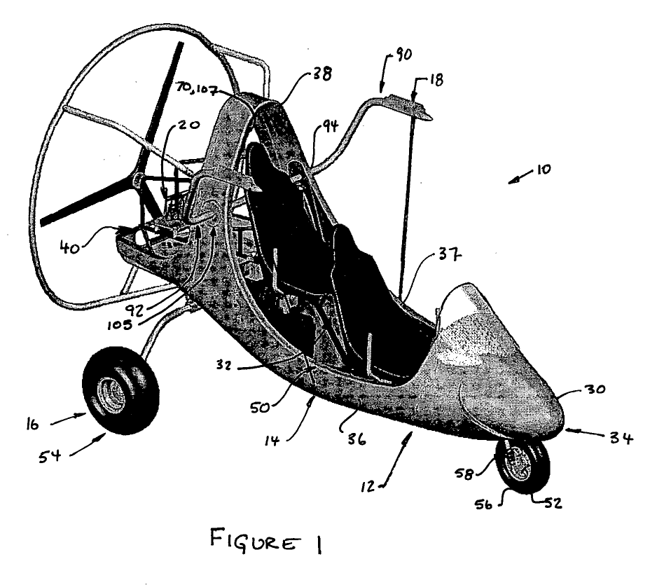

Referring now to the drawings and in particular to FIG. 1, powerchute 10 comprises vehicle 12 and a parachute (not shown). Vehicle 12 includes, body 14, landing gear 16, chute attachment assembly 18, and powerplant assembly 20. Body 14 comprises outer shell 30 and inner reinforcement 32. The outer shell and the inner reinforcement each comprise a carbon-fiber composite material and the two components are secured together by way of an epoxy to form a torsionally, axially and longitudinally stable body. Of course, in certain embodiments, additional fasteners may be utilized to attach the two components together. Advantageously, and unlike conventional powerchutes, the carbon fiber composite body is configured so as to be substantially fully weight bearing, and stable, so as to not require any additional structural frame (i.e., metal tubing frame). Indeed, a streamlined body is provided while conserving weight.

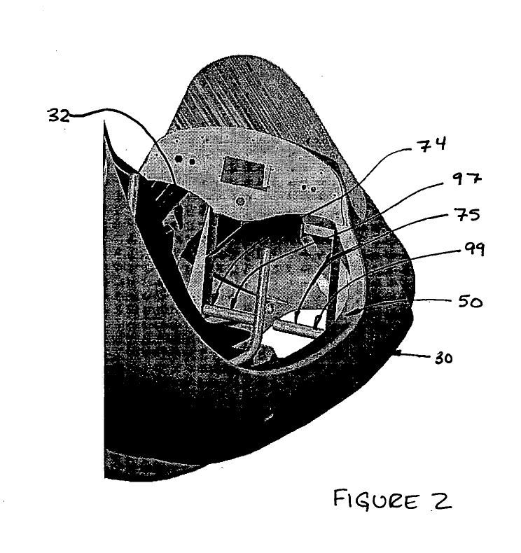

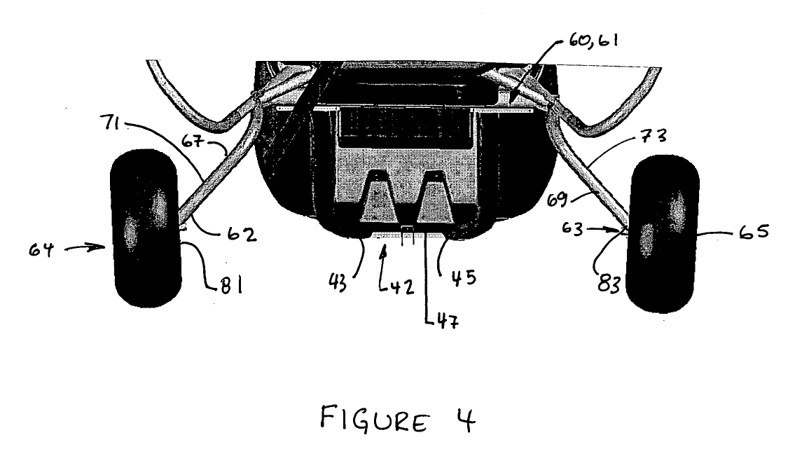

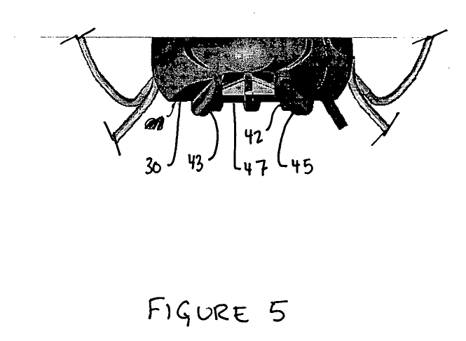

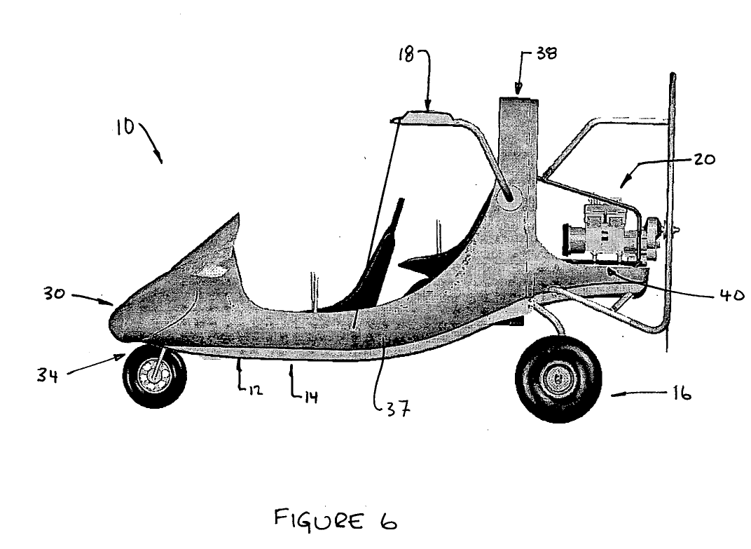

With reference to FIG. 1, outer shell 30 generally comprises a single integrated member which includes nose 34, opposing side panels 36, 37 (FIG. 6), roll bar 38, powerplant shelf 40, yaw control rail 42 (FIGS. 4 and 5). The various regions serve to define cavity 44 which includes cabin 48. As is shown in FIG. 2, the cabin meets the upper edge of the side panels and the roll bar about an outer ledge 50, which further contributes to the integrity and the structural rigidity of shell 30. In the embodiment shown, the cabin is configured for two individuals, wherein the second individual is positioned behind and vertically slightly above the first individual. Of course, the invention is not limited to any particular configuration of the cabin (i.e., front to back seating, side to side seating, etc.), or to any particular number of passengers.

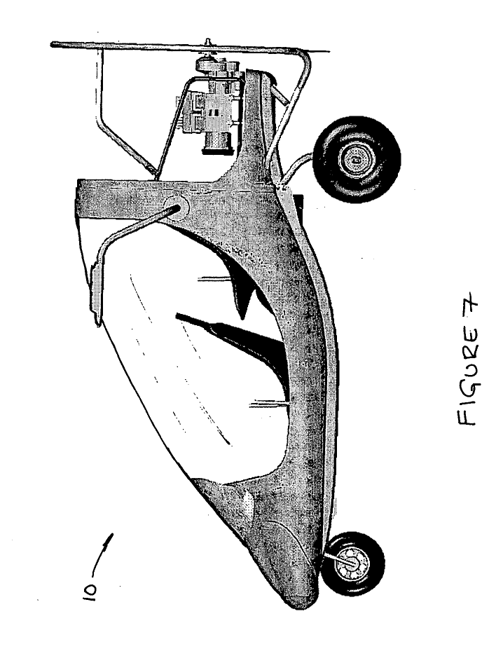

Roll bar 38 is shown in FIG. 1 as comprising a substantially u-shaped channel that extends above the rear seat within cabin 38. The front portion of roll bar 38 is integral with and forms a part of outer ledge 50 (while not required). The configuration of roll bar 38 defines an opening that extends from cavity 44 to powerplant shelf 40. Such an opening is well suited for the receipt and retention of an engine radiator, or to provide additional airflow for cooling an air cooled engine positioned on powerplant shelf 40. In certain embodiments, a canopy may be provided which fully encloses the cavity defined by the outer shell. One such canopy is shown in FIG. 7. It will be understood that a portion of or the entirety of the canopy may be transparent.

Referring now to FIGS. 4 and 5, aw control rail 42 is shown as comprising a channel extending from nose 34 to powerplant 40. The channel includes sides 43, 45 and top 47. Preferably, the channel comprises a constant cross-sectional area. Depending on the configuration of the underside of body 14, the channel may include a substantially uniform cross-sectional shape, or such a shape may be varied along the length thereof. Preferably, the channel is substantially axial, and substantially centered about a central axis of the body. Of course, other embodiments are contemplated. For example, while the channel is shown as including three sides, a fully enclosed channel (i.e., an tube-like opening extending through body 14 is likewise contemplated for use). Advantageously, and unlike conventional aircraft, such a channel extending along the length of the powerchute substantially increases the yaw stability of the powerchute, without substantially adversely affecting the performance of the powerchute.

Landing gear 16 is shown in FIG. 1 as comprising front landing gear 52 and rear landing gear 54. Front landing gear 52 includes wheel 56 and suspension 58. Rear landing gear 54 is shown in detail in FIG. 4 as comprising suspension 60, opposing axles 62, 63 and wheels 64, 65. Suspension 60 comprises a torsional suspension member 61 which terminates with outwardly and rearwardly extending trailing arms 67, 69. The trailing arms terminate, at sections 81, 83, proximate axles 62, 63 wherein they are substantially vertical. Thus, the trailing arms extend from torsional suspension member 61 in a substantially outward and horizontal direction, the trailing arms bend downwardly and outwardly along central section 71, 73, and finally the trailing arms proceed vertically substantially downward, as section 81, 83. Each arm generally comprises a metal tubular member which is bent and angled as desired. Of course, other materials are contemplated for use. Such a suspension provides a substantially wide track for the powerchute, and provides a exceedingly rugged suspension. Moreover, such a suspension is capable of absorbing substantial shock instead of transferring the shock to the passengers within the cabin.

Chute attachment assembly 18 is shown in FIG. 1 as comprising opposing arms 88, 90, opposing body mounts 92, 94, and control pedal assembly 74, 75 (FIG. 2). The opposing arms 88, 90 are generally mirror images of each other outside of the outer shell and connected together internally of the outer shell. Similarly, opposing body mounts are substantially identical. As such, opposing arm 88 and body mount 92 will be discussed with the understanding that opposing arm 90 and opposing body mount 94 are substantially identical outside of the shell. Opposing mount 92 comprises core 70, opposing carbon fiber composite panels on either side of core 70, substantially encapsulating the core. The composite panel on the outer side of the body may be integral with outer shell 30. Additionally, a core component can extend downwardly along the inner surface of outer shell 30. In one embodiment, core 70 comprises a wood-based material. Opposing arm 90 includes outer plate 105 and inner plate 107 which sandwiches the body mount therebetween. The outer plates and the mount are secured together by way of fasteners. Additionally, the opposing arms are secured to body 14 by way of cables, such as cables 96, 98.

Control pedals 74, 75 are associated with respective cables 97, 99. Cables 97, 99 are connected at the one end with the respective control pedals, and at the other end to the parachute (not shown). As such, when a pedal is pushed, a respective force is directed to the cable and the geometry of the chute is changed, altering the drag and forcing a change in direction. In certain embodiments, the pair of control pedals may be replaced with one or more control levers (actuated by a pilot's hands), or with a steering wheel.

Powerplant assembly 20 is shown in FIG. 1 as comprising engine 78, propeller 80, fuel tank (not shown), radiator 84 and propeller cage 86. Engine 78 may comprise an air cooled or a water cooled engine from any number of different manufacturers. Engine 78 is generally an “aircraft” standard four cylinder two-stroke motor, while others are contemplated. Engine 78 is secured to powerplant shelf 40 by way of fasteners. Where the engine comprises a water cooled engine, a radiator is preferably mounted through the opening defined byroll bar 38. Such a configuration directs a substantial amount of air through the radiator, providing the required cooling.

Propeller 80 is shown in FIG. 1 as comprising a three-blade fixed pitch propeller coupled to the output shaft of engine 78. Of course, the propeller is not limited to such a propeller, as other types of propellers (i.e., greater or lesser blades, and variable pitch blades) are contemplated for use. Propeller 80 is dimensioned such that a portion of the propeller passes beyond yaw control rail 42 proximate the end thereof. In such a configuration, propeller 80 serves to pull air into and through the yaw control rail. Such a configuration has been found to greatly increase the yaw stability of the vehicle.

The fuel tank is generally positioned below the second (rear) seat of the craft, so as to provide a low center of gravity for the vehicle. A fuel pump is provided inasmuch as the fuel tank is positioned vertically below the engine. Propeller cage 86 generally comprises a tubing member formed so as to extend beyond the span of the propeller in all directions wherein an individual may be poised to approach the propeller. In the embodiment shown, the tubing extends from a region above the longitudinal axis of the vehicle around each side to a region slightly above the opposing wheels 64, 65 of the rear landing gear 54. At such a point, the opposing tubing members turn inwardly so that they terminate proximate the engine and the powerplant shelf. Further support tubes extend from the primary tubing to discrete portions of the outer shell 30 of the vehicle to add structure and rigidity to the propeller cage.

The foregoing description merely explains and illustrates the invention and the invention is not limited thereto except insofar as the appended claims are so limited, as those skilled in the art who have the disclosure before them will be able to make modifications without departing from the scope of the invention.

1. A powerchute comprising:
a body having an outer shell and an inner reinforcement, the outer shell including a nose, opposing side panels, a roll bar and a powerplant shelf, wherein a plurality of the nose, opposing side panels, roll bar and powerplant shelf define a cavity including a cabin, and wherein the outer shell and the inner reinforcement comprise a carbon fiber composite which is of sufficient strength to maintain rigidity and structural integrity without the use of metal support members.

2. The powerchute of claim 1 wherein the outer shell and the inner reinforcement are secured together by way of an epoxy.

3. The powerchute of claim 1 wherein at least one of the outer shell and the inner reinforcement further comprises a yaw control rail.

4. The powerchute of claim 3 wherein the yaw control rail further comprises a channel extending along the body.

5. The powerchute of claim 4 wherein the channel includes opposing side surfaces and a top.

6. The powerchute of claim 4 wherein the cross-sectional area of the channel at any point of along the length thereof is substantially uniform.

7. The powerchute of claim 3 wherein the vehicle further includes a powerplant assembly having an engine and a propeller coupled therewith, the engine coupled with the powerplant shelf, the propeller positioned such that the propeller passes beyond a region proximate yaw control rail during a rotation thereof.

8. The powerchute of claim 1 further comprising a front landing gear and a rear landing gear, the rear landing gear comprising:
a torsional suspension component;
opposing trailing arms extending outwardly and downwardly away from the torsional suspension component;
opposing axles associated with each opposing trailing arm proximate a far end thereof; and
opposing wheels associated with each of the opposing axles.

9. The powerchute of claim 8 wherein the opposing trailing arms initiate in a substantially outward horizontal configuration proximate the torsional suspension component and terminate proximate the opposing axles in a substantially vertical orientation.

10. The powerchute of claim 10 wherein opposing trailing arms comprise substantially uniformly tubular components.

11. The powerchute of claim 1 further comprising a chute attachment assembly, the chute attachment assembly comprising opposing arms mounted to opposing body mounts, the opposing arms including plates which extend on either side of the respective body mount and secure the body mount between the plates.

12. The powerchute of claim 11 wherein the opposing arms are connected to each other within the cavity defined by the outer shell.

13. The powerchute of claim 12 wherein the opposing arms are each secured to opposing side panels by way of a cable.

14. The powerchute of claim 11 wherein the opposing body mounts further comprising a core and opposing carbon fiber composite panels substantially encapsulating the core.

15. The powerchute of claim 14 wherein the core comprises a wood material.

16. The powerchute of claim 1 further comprising a canopy over at least a portion of the cabin, at least a portion of the canopy being transparent.
